(19) United States
(12) Patent Application Publication
(10) Pub. No.: US 2003/0039112 A1
(43) Pub. Date: Feb. 27, 2003

(54) Front lighting assembly light guide and production method thereof

(76) Inventors: Shih-Chou Chen, Hsinchu (TW); Chung Kuang Shieh, Feng-Yuan City (TW); Chih-Han Fang, Hsinchu Hsien (TW); Yuh-Sheng Lin, Hsinchu (TW)

Correspondence Address: Keith Kline, PRO-TECHTOR INTERNATIONAL SERVICES, 20775 Norada Court, Saratoga, CA, 95070-3018, US

(21) Appl. No.: 09/934,613

(22) Filed: Aug. 21, 2001

(51) Int. Cl. F21V 7/04

(52) U.S. Cl. 362/31; 362/26

(57) ABSTRACT

A front lighting assembly light guide, comprising a light guide and a plurality of microstructures thereon. The light guide is laid on a front surface of a reflective LCD panel. A light source is placed at one end of the light guide. The plurality of microstructures are placed on a front surface of the light guide, deflecting light from the light source towards the LCD panel, illuminating the LCD panel. The plurality of microstructures are located isolated from each other, allowing to be distributed on the surface of the light guide at a spatial density according to the spatial intensity distribution of light from the light source, the density of microstructures increasing with lower light intensity. Thus uniform illumination of the LCD panel is achieved.

### BACKGROUND OF THE INVENTION

1. Field of the Invention

The present invention relates to a front lighting assembly light guide and production method thereof, particularly to a front lighting assembly light guide and production method thereof for use in a reflective liquid crystal display (LCD).

2. Description of Related Art

Contemporary liquid crystal display (LCD) panels divide into those that transmit light and those that reflect light from a light source. A light transmitting LCD panel is illuminated by a back lighting assembly. The back lighting assembly has a light guide which connects a light source, e.g. a cold cathode tube or a light emitting diode (LED), with a microstructure formed by a plurality of micro-reflectors. Thus a uniform flat back lighting source is formed which emits light that is transmitted through the LCD panel according to a pattern thereon.

A light reflecting LCD panel, on the other hand, is illuminated by a front lighting assembly or by exterior light, with light being reflected according to a pattern on the LCD panel.

A light transmitting LCD panel needs a light source for displaying a pattern. This requires constant power consumption, which shortens the time span until a battery is discharged. A light reflecting LCD panel, however, is able to rely on daylight or sufficient exterior lighting for displaying a pattern. Only if exterior lighting is insufficient, an internal light source is switched on. This reduces power consumption, lengthening battery discharge time for use in portable devices.

For this reason, light reflecting LCD panels are especially suitable for small portable devices like personal digital assistants (PDA), mobile phones or notebook computers. As shown in FIG. 5, a conventional light reflecting LCD panel comprises: a light guide 1, attached to a front surface of an LCD panel 2; a linear light source 3 on one lateral side of the light guide 1; and a plurality of V-shaped grooves 4 in a front surface of the light guide 1, reflecting light from the light source 3 towards the front surface of an LCD panel 2, so that a uniform flat light source is generated.

Referring to FIG. 6, for manufacturing the light reflecting LCD panel, the V-shaped grooves 4 in the front surface of the light guide 1 are arranged parallel to the light source 3, with the V-shaped grooves 4 extending from one lateral side of the light guide 1 to the opposite lateral side. The V-shaped grooves 4 are made by a micro-cutting tool using flying cutting and are arranged at a relatively low density towards the light source 3 and at a relatively high density away from the light source 3. This gradient of density of the V-shaped grooves 4 ensures uniform light emission.

The V-shaped grooves 4 are usually cut into the front surface of the light guide 1 by a diamond micro-cutting tool using flying cutting. Alternatively, a microstructure of steps or peaks is cut. The method of working, however is the same as just described. In any case, a linear structure is cut into the front surface of the light guide 1.

The conventional method of cutting the V-shaped grooves 4 results in the V-shaped grooves 4 having uniform widths and depths, leaving only varying of the density of the V-shaped grooves 4 as a way to achieve uniform light emission. However, light coming from the light source 3 is attenuated along the light guide 1 in both a longitudinal direction and a transversal direction, i.e., perpendicular and parallel to the V-shaped grooves 4. Varying of the distances thereof only compensates for light attenuation along the light guide 1 perpendicular to the V-shaped grooves 4, but not parallel to the V-shaped grooves 4. If the light guide 1 is too wide, side parts thereof are insufficiently illuminated. Thus there is a restriction to the width of the light guide 1, and conventional light reflecting LCD panels are only applicable to small displays, not to large displays.

Furthermore, a micro-cutting tool is required for cutting the V-shaped grooves 4 into the front surface of the light guide 1. Due to a limited cutting speed, this consumes much time and slows down manufacturing of the light reflecting LCD panel, increasing production cost. The cutting tool usually has a diamond edge, which puts restrictions on the size thereof. Thus too high a density of the V-shaped grooves 4 on the light guide 1 is not possible and cutting traces are left, impairing the quality of the light reflecting LCD panel.

### SUMMARY OF THE INVENTION

The main object of the present invention is to provide a front lighting assembly light guide which ensures uniform emission of light from a light reflecting LCD panel and is applicable to a large light reflecting LCD panel, and to provide a production method thereof.

Another object of the present invention is to provide a front lighting assembly light guide and a production method thereof which is faster and reduces production cost.

The present invention can be more fully understood by reference to the following description and accompanying drawings.

### BRIEF DESCRIPTION OF THE DRAWINGS

FIG. 1 is a perspective view of the front lighting assembly light guide of the present invention.

FIG. 2 is a schematic side view of the front lighting assembly light guide of the present invention.

FIG. 3 is a plan view of the front lighting assembly light guide of the present invention.

FIGS. 4A-4G are schematic illustrations of the production of the front lighting assembly light guide according to the method of the present invention.

FIG. 5 is a schematic side view of a conventional front lighting assembly light guide.

FIG. 6 is a perspective view of a conventional front lighting assembly light guide.

### DETAILED DESCRIPTION OF THE PREFERRED EMBODIMENT

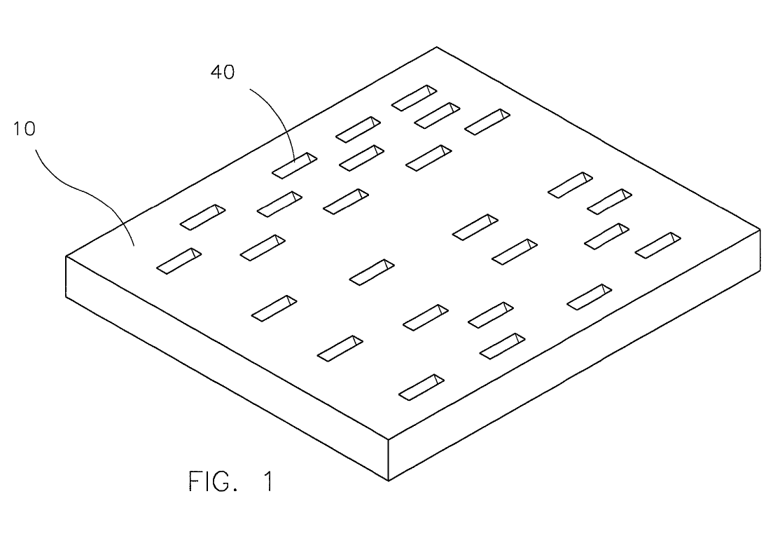

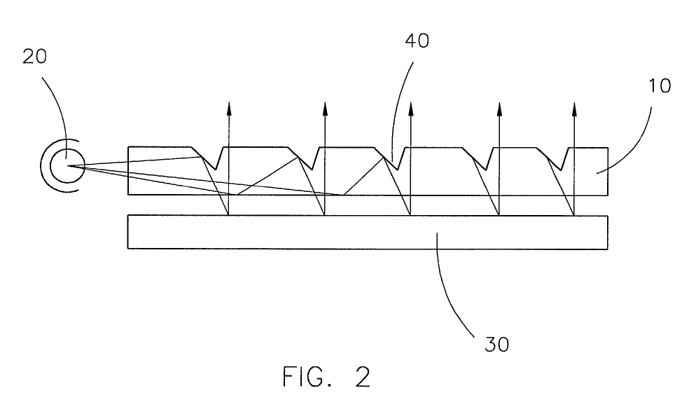

As shown in FIGS. 1-2, the front lighting assembly light guide of the present invention mainly comprises: a light guide 10, made of transparent plastics material, having a near end at which a light source 20 is placed, from where light enters the light guide 10 and passes through towards a far end of the light guide 10; an LCD panel 30, attached to a back surface of the light guide 10; and a plurality of microstructures 40 on a front surface of the light guide 10. The plurality of microstructures 40 are groovelets that are not connected to each other and are capable of deflecting light from the light source 20 towards the LCD panel 30, illuminating the LCD panel 30.

Referring to FIG. 2, light from the light source 20 passes along the light guide 10 and, when hitting one of the microstructures 40, is deflected thereby towards a front surface of the LCD panel 30, then reflected therefrom and passes through the light guide 10. This results in a pattern on the LCD panel being displayed. Light from the light source 20 is deflected by an angle that depends on the shape of the microstructures 40 and the material of the light guide 10.

In the embodiment explained here, the present invention has microstructures 40 that are V-shaped groovelets. However, other suitable shapes are possible. There is no restriction to the shapes shown in the Figs.

Referring to FIGS. 1-3, the main characteristic of the present invention is that the microstructures 40 are not mutually connected. By this arrangement, the light guide 10 obtains a front surface which deflects light propagating along two dimensions, i.e., along a longitudinal and a transversal directions. A variation of density of the microstructures 40 in both the longitudinal and the transversal directions is possible. Thus attenuation of light from the light source 20 is compensated for in all directions, and the LCD panel 30 is uniformly illuminated.

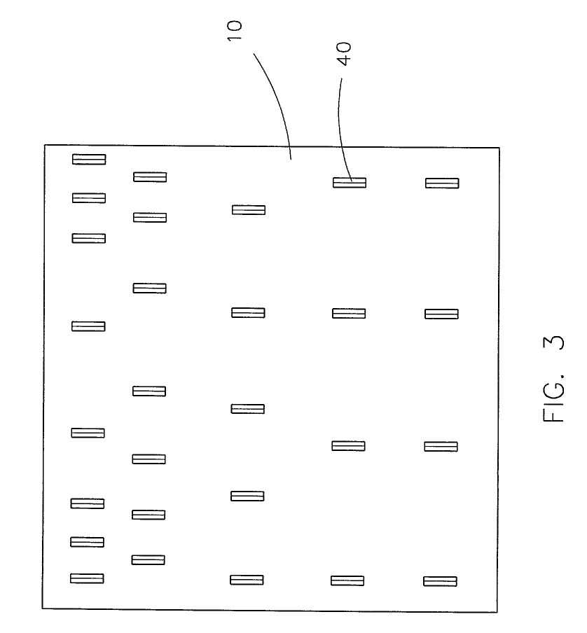

Referring again to FIG. 3, light from the light source 20, while spreading through the light guide 10, is attenuated both in the longitudinal and the transversal directions. Light intensity is lowest at a far end of the lightguide 10 which is opposite to the near end thereof, close to two transversal edges. In these two regions, a comparatively high density of microstructures 40 is provided for to achieve high reflectivity of light towards the LCD panel 30. The closer the light source 20 is approached, the higher light intensity becomes and therefore the lower the density becomes at which microstructures 40 are disposed, reducing reflectivity of light towards the LCD panel 30. Thus the LCD panel 30 is uniformly illuminated.

As compared to a conventional front lighting assembly light guide, the present invention, by employing isolated microstructures 40, allows for varying of the density thereof also in the transversal direction, so that light is deflected with uniform density across the light guide 10 and the LCD panel 30, when illuminated, is exposed to uniform intensity. Thus the problem of nonuniform distribution of light intensity across a reflective LCD panel is overcome, allowing to use the present invention in conjunction with large reflective LCD panels.

The microstructures 40 of the present invention are not produced by micro-cutting, but rather by ion or light etching. This avoids the limitations of working by micro-cutting and allows to distribute the isolated microstructures 40 on the front surface of the light guide 10.

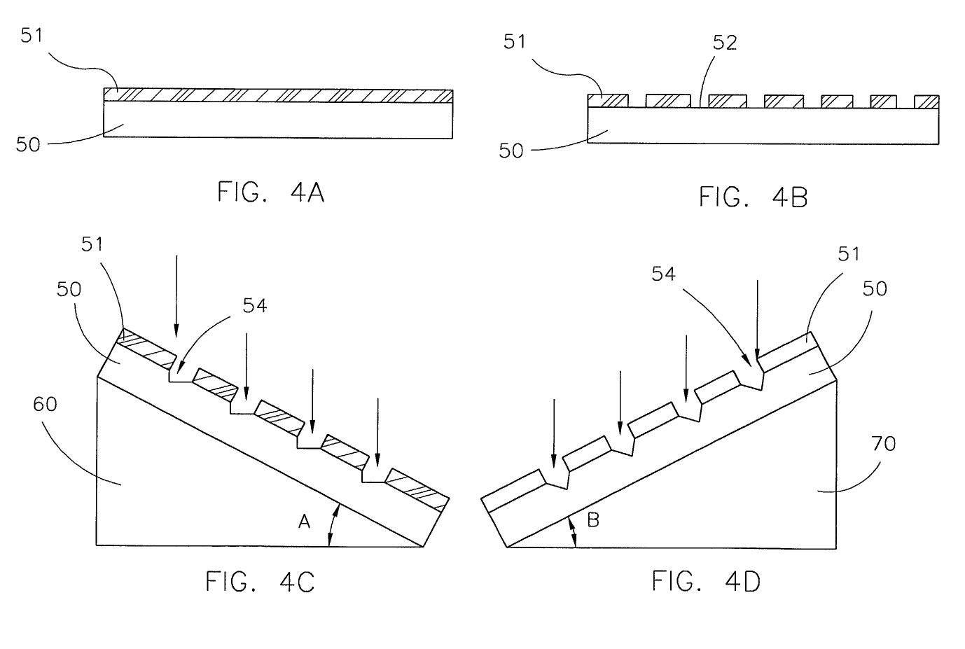

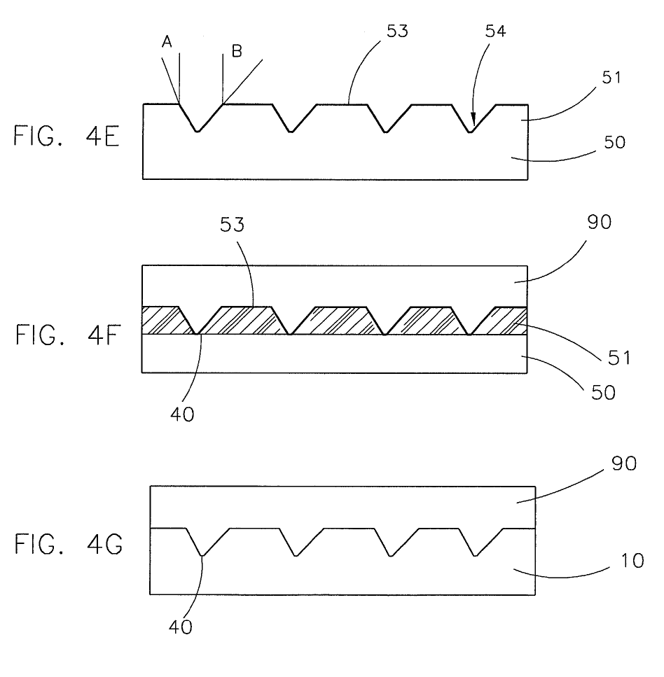

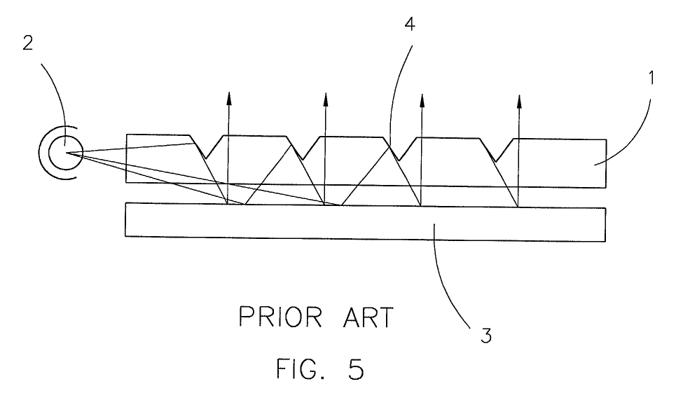

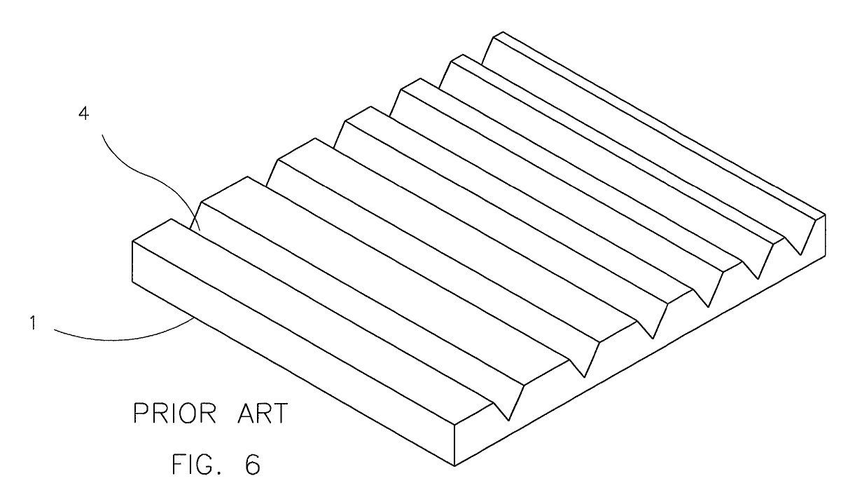

As shown in FIG. 2, the microstructures 40 are V-shaped groovelets. Referring to FIGS. 4A-4G, production of the microstructures 40 comprises the following steps: First, as shown in FIG. 4A, a planar substrate 50 is coated by a photoresist layer 51. Then, as shown in FIG. 4B, light exposure through a mask 52 is performed and, as shown in FIG. 4C, the substrate 50 is put on a working seat 60 at an inclined angle A. At this angular position, groovelets 54 are engraved by ion etching from above, so that on one side lateral angles A with respect to the surface of the substrate result. After this, as shown in FIG. 4D, the substrate 50 is put on a working seat 70 at an opposite inclined angle B. At this angular position, the groovelets 54 are worked on the other side by ion etching from above, so that on the other side lateral angles B with respect to the surface of the substrate result.

As shown in FIG. 4E, when the groovelets 54 are finished, a seed layer 53 is placed the substrate 50 with the mask 52. The seed layer 53 is a metal, Cu, Ni or Ag. Then, as shown in FIG. 4F, a stamper 90 is grown on the seed layer 53 by electroforming. After that, the stamper 90 is removed and, as shown in FIG. 4G, placed on a mold to produce the light guide 10 by plastic injection molding, with the front surface with the microstructures 40 of the light guide 10 being formed according to the stamper 90.

By employing the method described above, the present invention is able to overcome the shortcomings of conventional working by micro-cutting, with isolated microstructures being produced. Thus any variation of the density of the microstructures is achieved. For producing the microstructures 40, light exposure through a mask and ion etching are used to make a stamper 90 and the light guide 10 including the microstructures 40 is made by plastic injection molding, allowing for mass production in a short time of light guides with resulting low cost. For changing the lateral angles of the microstructures 40, simply the angles A, B of the working seats 60, 70 are changed.

While the invention has been described with reference to a preferred embodiment thereof, it is to be understood that modifications or variations may be easily made without departing from the spirit of this invention which is defined by the appended claims.

1. A front lighting assembly light guide, comprising:
a light guide, having a near end where a light source is placed, emitting light which penetrates said light guide from said near end towards an opposite far end; and
a plurality of microstructures on a front surface of said light guide, deflecting light from said light source towards an LCD panel, illuminating said LCD panel, with said plurality of microstructures being located isolated from each other, allowing to be distributed on said surface of said light guide.

2. A front lighting assembly light guide according to claim 1, wherein said plurality of microstructures are V-shaped grooves.

3. A front lighting assembly light guide according to claim 1, wherein said plurality of microstructures are arranged on said light guide at a density that corresponds to a spatial intensity distribution of light from said light source.

4. A method for producing a front lighting assembly light guide, comprising the steps of:
a. coating of a substrate with a photoresist layer;
b. exposing said photoresist layer to light and developing, so as to generate a photoresist pattern, then ion etching of said substrate at a first lateral angle, thereby producing a first lateral side of micro-incisions which is inclined at said first lateral angle;
c. ion etching of said substrate at a second lateral angle, thereby producing a second lateral side of said micro-incisions opposite to said first lateral side which is inclined at said second lateral angle, so that V-shaped groovelets are formed, then removing said photoresist layer;
d. covering a surface of said substrate with said groovelets with a metal seed layer;
e. generating a stamper on said surface of said planar substrate with said groovelets by electroplating, so that said stamper has a surface inverse to said surface of said substrate with said groovelets;
f. forming a light guide using said stamper, resulting in a front surface of said light guide with a plurality of V-shaped microstructures.

5. A method for producing a front lighting assembly light guide according to claim 4, wherein said substrate while being ion-etched is placed on a working seat, so that said substrate is inclined at said first or second lateral angles.
